(19) United States
(12) Patent Application Publication
(10) Pub. No.: US 2021/0109546 A1
(43) Pub. Date: Apr. 15, 2021

(54) PREDICTIVE LANDING FOR DRONE AND MOVING VEHICLE

(71) Applicants: Hyundai Motor Company, Seoul (KR); Kia Motors Corporation, Seoul (KR)

(72) Inventors: Amanda Christiana, Ann Arbor, MI (US); Charles Moore, Mcfarland, WI (US); Margaux Krause, Pinckney, MI (US)

(21) Appl. No.: 16/601,193

(22) Filed: Oct. 14, 2019

(51) Int. Cl. G05D 1/06; B64C 39/02; G05D 1/10

(52) U.S. Cl. CPC G05D 1/0684; B64C 2201/18; G05D 1/101; B64C 39/024

(57) ABSTRACT

A method for predictive drone landing is provided. The method includes obtaining a relative position of a drone with respect to a landing dock mounted on a vehicle, obtaining a relative velocity of the drone with respect to the landing dock, estimating a time of landing based on the relative position and the relative velocity of the drone with respect to the landing dock, and predicting a location of the vehicle at the estimated time of landing as a drone landing location based on driving data of the vehicle and flight conditions of the drone. In particular, the drone landing location is predicted based on at least one of a speed of the vehicle, a calculated vehicle route from a navigation system, a road traffic condition, a 2-D map data, a 3-D map data, advanced driver-assistance system (ADAS) data, and traffic data received via a vehicle-to-everything (V2X) communication.

### TECHNICAL FIELD

The present disclosure relates to a drone landing system for a vehicle, and more particularly, to a method and a system for landing a drone on a vehicle with a predictive guidance.

### BACKGROUND

Drone systems are widely used for military, commercial, scientific, recreational, and agricultural purposes, and their applications include surveillance, delivery, aerial photography, and the like. Drones have been also developed to take off from and land on a vehicle. The vehicle-based drone systems are more versatile, flexible, and energy efficient. In the vehicle-based drone systems, a landing dock mounted on the vehicle is used as a base for charging and transporting.

In an example of package delivery using a vehicle-based drone system, a large number of packages may be loaded within a vehicle (e.g., a truck or a van), and a drone may be stationed on a roof of the vehicle. When the vehicle approaches a delivery area, the drone may load a package, take off from the vehicle, and deliver the package to a destination. After the delivery, the drone may return to the vehicle, land thereon, load another package, take off, and deliver the package. For more efficient delivery, the drone may perform the delivery operation while the vehicle is moving.

Landing a drone on a landing dock mounted, for example, on a roof of a vehicle, without a collision or a missed landing requires accurate coordination and timing. To land a drone on a moving vehicle, a vision recognition-based guidance system or a global position system (GPS)-based guidance is typically used. In these conventional methods, the drone is guided toward the current location of the vehicle. When the vehicle changes paths, the location of the vehicle is required to be updated in real time, and the drone reactively follows the current location of the vehicle until the drone lands on the vehicle.

However, while a path of the vehicle is generally restricted to a road on the surface of the earth, the drone has significantly less restrictions in regards to the flight path. When the drone reactively follows the vehicle, the drone is also forced to generally follow the road pattern, which may be an inefficient path for the drone to reach a landing point. Accordingly, the conventional methods provide a less efficient guidance, thereby increasing a time to land and power consumption. Moreover, when the drone is unable to react promptly to behaviors of the vehicle, there is also an increased risk for a collision or a missed landing. Furthermore, in the conventional methods, a driver of the vehicle is often required to maintain the vehicle at a constant and steady speed, which imposes a burden for the driver and also a risk for the surrounding traffic.

### SUMMARY

The present disclosure provides a method of predictive guidance for landing a drone on a vehicle and a system for predictive landing of a drone on a vehicle, to prevent a missed landing or a collision during the landing.

In accordance with an aspect of the present disclosure, a method for predictive drone landing may include obtaining a relative position of a drone with respect to a landing dock mounted on a vehicle and obtaining a relative velocity of the drone with respect to the landing dock by a processor. Based on the obtained relative position and the relative velocity of the drone with respect to the landing dock, the processor may be configured to estimate a time of landing. Subsequently, the processor may be configured to predict a location of the vehicle at the estimated time of landing as a drone landing location based on driving data of the vehicle and flight conditions of the drone. In particular, the drone landing location may be predicted based on at least one of a speed of the vehicle, a calculated vehicle route from a navigation system, a road traffic condition, a 2-D map data, a 3-D map data, advanced driver-assistance system (ADAS) data, and traffic data received via vehicle-to-everything (V2X) communication. The calculated route from the navigation system may include road curves and/or elevations.

One or more of the following features may be included in any feasible combinations.

The processor may be configured to update the estimated time of landing based on the predicted location of the vehicle, and also update the predicted location of the vehicle based on the updated time of landing. Further, the processor may be configured to guide the drone to the drone landing location. When the drone is guided, the processor may be configured to generate a drone route to reach the drone landing location at the estimated time of landing, and provide the drone with the generated drone route. Subsequently, the processor may be configured to determine whether a distance between the drone and the landing dock is within a predetermined distance, and may be configured to execute landing when the distance between the drone and the landing dock is within the predetermined distance. The relative position of the drone with respect to the landing dock may be obtained using an imaging device. The route may be generated to circumvent an obstacle between the drone and the drone landing location.

In addition, the processor may be configured to determine whether the estimated time of landing is within a predetermined time. When the estimated time of landing is within the predetermined time, the processor may be configured to predict an attitude of the drone and an attitude of the vehicle at the estimated time of landing, estimate a difference between the attitude of the drone and the attitude of the vehicle, and adjust orientation angles of the landing dock based on the estimated difference of the attitudes. The predetermined time may be a sum of a predetermined buffer and an actuation time required to adjust the landing dock to correspond to the predicted attitude of the drone. For example, the predetermined buffer may be about 1 second. The landing may be executed using magnetic coupling between the drone and the landing dock. Alternatively, the landing may be executed using a mechanical capturing device.

The processor may be configured to transmit a current location and/or orientation of the vehicle to the drone based on a global position system (GPS), and provide the drone with a route to the current location of the vehicle. The processor may also be configured to receive a detection signal which indicates that the relative position of the drone with respect to the landing dock is detected using an imaging device. In response to receiving the detection signal, the processor may be configured to obtain the relative position of the drone with respect to the landing dock. The processor may be configured to estimate a remaining flight duration of the drone and determine whether the remaining flight duration of the drone is longer than a time to the estimated time of landing. Additionally, the processor may be configured to estimate a remaining cruise duration of the vehicle and determine whether the remaining cruise duration of the vehicle is longer than the time to the estimated time of landing. During the method for predictive drone landing, the vehicle may be moving.

In accordance with another aspect of the present disclosure, a system for predictive drone landing may include a landing dock mounted on a vehicle and a controller that includes a memory configured to store program instructions and a processor that is configured to execute the program instructions. When the program instructions are executed, a relative position and an orientation of a drone with respect to the landing dock and a relative velocity of the drone with respect to the landing dock may be obtained. Further, based on the relative position and the relative velocity of the drone with respect to the landing dock, a time of landing may be estimated. Subsequently, a location of the vehicle at the estimated time of landing may be predicted as a drone landing location based on driving data of the vehicle and flight conditions of the drone. In particular, the drone landing location may be predicted based on at least one of a speed of the vehicle, a calculated vehicle route from a navigation system, a road traffic condition, a 2-D map data, a 3-D map data, advanced driver-assistance system (ADAS) data, and traffic data received via vehicle-to-everything (V2X) communication.

The predictive guidance for landing a drone on a vehicle according to exemplary embodiments of the present disclosure may autonomously guide a drone toward a vehicle based on a prediction of the vehicle location at an estimated time of landing, compared with a reactive guidance of related art. Therefore, the predictive guidance according to the present disclosure may decrease a time required for the landing procedure and also decrease a chance for a collision or a missed landing. Further, the predictive guidance of the drone may decrease the energy consumption by planning a more effective (e.g., shortest) route and by requiring less frequent control instructions. The predictive guidance of the drone may also minimize intervention and effort from a driver of the vehicle.

Notably, the present disclosure is not limited to the combination of the elements as listed above and may be assembled in any combination of the elements as described herein. Other aspects of the disclosure are disclosed infra.

### BRIEF DESCRIPTION OF THE DRAWINGS

A brief description of each drawing is provided to more sufficiently understand drawings used in the detailed description of the present disclosure.

FIG. 1 shows a vehicle-based drone system according to an exemplary embodiment of the present disclosure;

FIG. 2 illustrates a schematic of a drone guidance according to an exemplary embodiment of the present disclosure;

FIG. 3 illustrates a schematic of a predictive guidance mode according to an exemplary embodiment of the present disclosure;

FIG. 4 shows a flowchart for a method of predictive drone landing according to an exemplary embodiment of the present disclosure;

FIG. 5 shows a flowchart for a method of predictive drone landing according to another exemplary embodiment of the present disclosure;

FIG. 6 shows a flowchart for a method of predictive drone landing according to yet another exemplary embodiment of the present disclosure;

FIG. 7 schematically compares initiation of path changes of a drone with the predictive landing according to exemplary embodiments of the present disclosure with a drone in the related art; and

FIG. 8 schematically compares initiation of orientation changes of a drone with the predictive landing according to exemplary embodiments of the present disclosure with a drone in the related art.

It should be understood that the above-referenced drawings are not necessarily to scale, presenting a somewhat simplified representation of various features illustrative of the basic principles of the disclosure. The specific design features of the present disclosure, including, for example, specific dimensions, orientations, locations, and shapes, will be determined in part by the particular intended application and use environment.

### DETAILED DESCRIPTION

Advantages and features of the present disclosure and a method of achieving the same will become apparent with reference to the accompanying drawings and exemplary embodiments described below in detail. However, the present disclosure is not limited to the exemplary embodiments described herein and may be embodied in variations and modifications. The exemplary embodiments are provided merely to allow one of ordinary skill in the art to understand the scope of the present disclosure, which will be defined by the scope of the claims. Accordingly, in some embodiments, well-known operations of a process, well-known structures, and well-known technologies will not be described in detail to avoid obscure understanding of the present disclosure. Throughout the specification, same reference numerals refer to same elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

An aspect of the present disclosure provides a predictive guidance of a drone for landing on a landing dock mounted on a vehicle. According to exemplary embodiments of the present disclosure, a drone may be guided to the vehicle based on a prediction of the vehicle location at an estimated time of landing, thereby decreasing a time required for the landing procedure, and also decreasing a chance for a collision or a missed landing. Moreover, the drone may begin adjusting a flight path prior to the vehicle changing a path (e.g., turning, etc.). Accordingly, a shortest route may be provided using the predictive landing, the guidance instructions are required less frequently, and thus, the power consumption may be decreased. The predictive landing of a drone may also minimize intervention and effort from a driver of the vehicle.

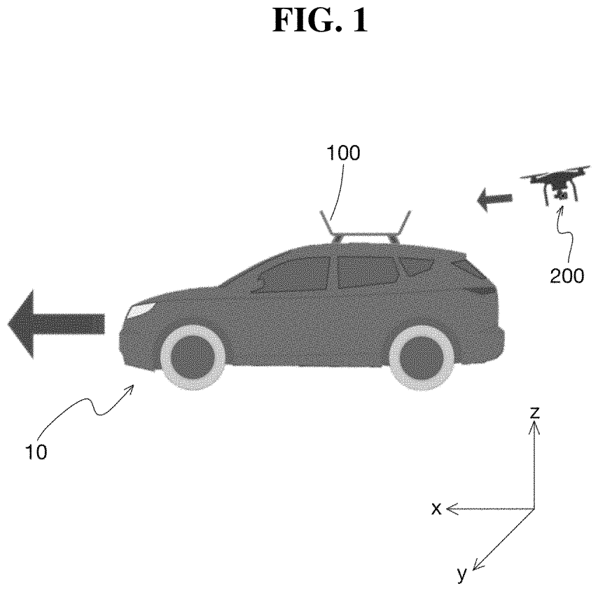

FIG. 1 shows an exemplary system for a vehicle-based drone according to an exemplary embodiment of the present disclosure. Referring to FIG. 1, a vehicle 10 may include a landing dock 100 to provide a platform for a drone 200 to land. The platform may be used for charging the drone, ground-transportation of the drone, and/or for uploading or downloading payloads. The landing dock 100 may be mounted on a roof of the vehicle. However, the location of the landing dock 100 is not limited thereto, and may be varied. For example, the landing dock 100 may be mounted on a towed trailer or a separate compartment provided on the vehicle.

The drone 200 may be any unmanned aircraft or uncrewed aircraft (UA), which is an aircraft without a human pilot on board. The UA may include a remotely piloted aircraft (RPA), a remotely piloted aircraft system (RPAS), an unmanned aerial vehicle or an uncrewed aerial vehicle (UAV), an unmanned aircraft system (UAS), or the like. The drone 200 that may be employed in the predictive guidance system according to exemplary embodiments of the present disclosure is not particularly limited. For example, the drone 200 may be for a recreational purpose, a commercial purpose, a military purpose, or the like. The drone 200 may include a rotary wing type, a fixed wing type, or a hybrid thereof. The drone 200 may also have a capability to be piloted autonomously.

Further, the landing dock 100 may receive the drone 200 thereon and/or may maintain the drone 200 in an anchored state until a next take off. The landing dock 100 may include a magnetic device to couple with the drone 200 for landing. In some exemplary embodiments, the landing dock 100 may include a device that mechanically captures the drone 200 for landing and/or for anchoring. Between aerial missions, the drone 200 may be anchored to the landing dock 100 and transported by the vehicle while recharging a battery mounted within the drone 200. In particular, the landing dock 100 may include a dock actuator configured to adjust angles of the landing dock 100 about a longitudinal direction (e.g., x-axis), a transverse direction (e.g., y-axis), and vertical direction (e.g., a z-axis) with respect to the vehicle to allow the drone 200 to land at various angles. The angle adjustment capability of the landing dock 100 may increase the effectiveness of the predictive landing.

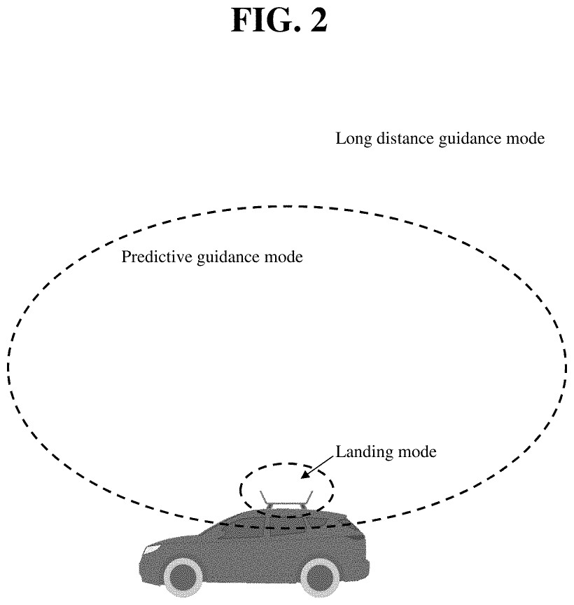

FIG. 2 illustrates a schematic of a drone guidance according to an exemplary embodiment of the present disclosure. Referring to FIG. 2, the drone may be guided for landing on the vehicle through three modes, namely, a long distance guidance mode, a predictive guidance mode, and a landing mode. In particular, in the long distance guidance mode, the drone 200 may perform aerial tasks with or without guidance from the vehicle. Upon determining a requirement for returning to the vehicle 10 for landing, the drone 200 may be configured to acquire a location and/or an orientation of the vehicle 10. The location of the vehicle 10 may be determined by receiving a signal from a global positional system (GPS) mounted within the vehicle 10. In one embodiment, the location and the orientation of the vehicle 10 may be obtained or enhanced using an inertial measurement unit (IMU) and/or an advanced driver-assistance system (ADAS) of the vehicle 10. The IMU may include an accelerometer and/or a gyroscope to calculate the location and the orientation of the vehicle 10 without an external reference. The location and the orientation of the vehicle 10 may be transmitted to the drone 200. The location and the orientation of the vehicle 10 may be transmitted to the drone 200 via a wireless communication link. The wireless communication link that may be used in the drone guidance system according to the present disclosure is not particularly limited, and may include any transmission protocol or network (e.g., radio, WiFi, cellular, Bluetooth, and the like). The wireless communication may also utilize a controller area network (CAN) and/or a vehicle-to-everything (V2X) protocol, for example, vehicle-to-vehicle (V2V), vehicle-to-network (V2N), and vehicle-to-roadside infrastructure (V2I).

Upon determining the location of the vehicle 10, the drone 200 may be guided toward the acquired location of the vehicle 10. Instructions to guide the drone 200 toward the vehicle 10 may be generated by a processor provided in the drone 200. However, the present disclosure is not limited thereto, and the guidance instructions for the drone 200 may be generated by a processor provided in the vehicle 10 and may be transmitted to the drone 200 via the wireless communication link. The guidance instructions may also be generated by a processor of a guidance server that is extraneous to the vehicle 10 and the drone 200. The extraneous guidance server may be configured to communicate with vehicle 10 and the drone 200 via the wireless communication link.

The instructions to guide the drone 200 toward the vehicle 10 may include information regarding an adjustment of an attitude, a speed, and/or an acceleration of the drone 200. The attitude of the drone may refer to a roll angle, a pitch angle, and a yaw angle. The roll angle may refer to an angle of rotation about a longitudinal principal axis (e.g., x-axis) of the drone 200 with respect to a horizontal plane (e.g., x-y plane). The pitch angle may refer to an angle of rotation about a transverse principal axis (e.g., y-axis) of the drone 200 with respect to the horizontal plane (e.g., x-y plane). The yaw angle may refer to an angle of rotation about a vertical principal axis (e.g., z-axis) of the drone 200 with respect to a vertical plane (e.g., z-x plane).

Additionally, in the long distance guidance mode, the drone 200 may be configured to attempt detecting the vehicle 10 and/or the landing dock 100 using an imaging device. In response to detecting the vehicle 10 and/or the landing dock 100 using the imaging device, the drone guidance according to an exemplary embodiment of the present disclosure may switch from the long distance guidance mode to a predictive guidance mode. In some implementations, the imaging device may be mounted within the vehicle 10 to detect the drone 200. In these implementations, in response to detecting the drone 200 using the imaging device of the vehicle 10, the drone guidance may switch from the long distance guidance mode to a predictive guidance mode.

In an exemplary embodiment, the switch from the long distance guidance mode to the predictive guidance mode may be triggered when the drone 200 is within a predetermined distance from the vehicle 10, for example, about 10 m to about 1 km. The distance may be determined based on surrounding environment, wireless communication range, local weather conditions, or the like. In some exemplary embodiments, the switch from the long distance guidance mode to the predictive guidance mode may be triggered upon receiving a control signal to switch the modes. Additionally, the predictive guidance mode may be used as a default guidance mode. Further, the long distance guidance mode may be omitted.

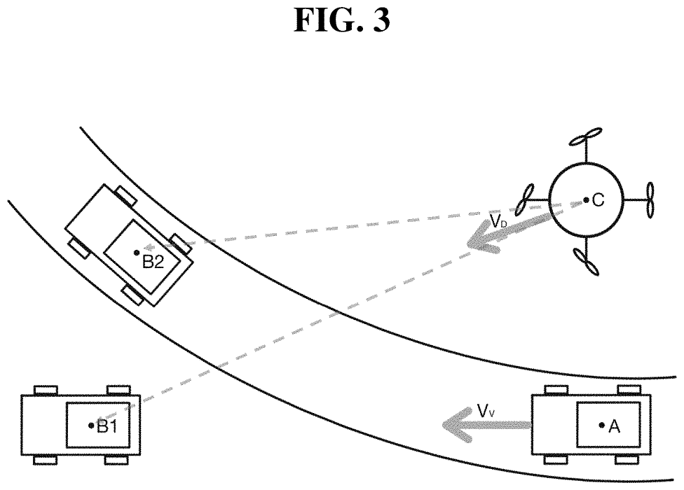

Moreover, FIG. 3 illustrates a schematic of a predictive guidance mode according to an exemplary embodiment of the present disclosure. Referring to FIG. 3, at a given time, the vehicle 10 and the drone 200 may be at locations A and C, respectively, and may have velocities V_{V} and V_{D}, respectively. Based on the locations of the drone 200 and the landing dock 100 and the velocities of the drone 200 and the landing dock 100 (i.e., the velocity of the vehicle 10), a time of landing may be estimated. Subsequently, a location of the vehicle 10 at the estimated time of landing may be predicted. The predicted location of the vehicle 10 may be defined as a drone landing location.

For example, the drone landing location may be predicted based on the velocity V_{V} of the vehicle 10 at the given time. In this case, the drone landing location may be predicted to be location B₁ shown in FIG. 3. Accordingly, the drone 200 may be guided to location B₁. As another example, based on various driving data of the vehicle, the drone landing location may be predicted as location B₂ shown in FIG. 3. Accordingly, the drone 200 may be guided to location B₂. Since location B₂ is a more probable and realistic location of the vehicle 10 at the time of landing, utilizing the driving data of the vehicle may provide more accurate predictions, thereby decreasing a time required for the landing procedure, and providing a more efficient guidance.

Alternatively, the time of landing may be assigned or pre-set instead of being estimated. In other words, when no interception is predicted based on the current locations and the current velocities of the drone 200 and the vehicle 10, the time of landing may be assigned by a controller of the vehicle, the drone landing location may be predicted based on the assigned time of landing, and the drone 200 may be provided with instructions to adjust the heading and/or the speed to reach the predicted drone landing location at the assigned time of landing.

As discussed above, utilizing the driving data of the vehicle may provide more accurate predictions of the drone landing location and the time of landing. Examples of the driving data that may be used to predict the location and/or the orientation of the vehicle at the estimated time of landing may include, but not limited to, a speed of the vehicle, a vehicle route calculated by a navigation system of the vehicle, a road traffic condition, a 2-D map data, a 3-D map data, an ADAS data, and traffic conditions data received via the V2X communication. The driving data may be pre-stored in the controller of the vehicle or may be obtained from an external source. For example, the road traffic condition may be obtained from an external source and updated in real time via a wireless communication link. Furthermore, the road traffic condition may be collected by the drone. In particular, the drone may use an imaging device and/or wireless communication system to obtain speed of the vehicle, obtain speeds of surrounding vehicles, or detect obstacles on or near the path of the vehicle. The 3-D map data may provide more accurate predictions of the drone landing location and the time of landing since the 3-D map data includes elevation changes of the road, which adds another dimension to the predicted location and orientation of the vehicle 10.

Further, the controller may be configured to generate a drone route to reach the drone landing location at the time of landing. The drone route may be generated based on a heading angle and a final descent speed of the drone 200 to match the orientation angle and the speed of the vehicle 10 and/or the landing dock 100 at the time of landing. The generated drone route may be transmitted to the drone 200 from the controller. Alternatively, the drone may be configured to generate the route based on the drone landing location and the time of landing. In other words, the drone landing location and the time of landing may be transmitted to the drone 200, and the drone 200 may generate the route to reach the drone landing location at the time of landing. Predicted orientation angle and the speed of the vehicle 10 may also be transmitted to the drone 200, and the drone 200 may be configured to generate the route to match the heading angle and the final descent speed to match the orientation angle and the speed of the vehicle 10 at the time of landing. Further, the drone route may be generated by an extraneous guidance server and transmitted to the drone 200 via a wireless communication link. In generating the drone route, wind data may be also accounted for.

Referring to FIG. 2 again, the drone guidance according to an exemplary embodiment of the present disclosure may include a landing mode. In this mode, the distance between the drone 200 and the landing dock 100 may be monitored, and the landing may be executed in response to determining that the distance between the drone 200 and the landing dock 100 is within a predetermined distance. The landing may be executed using a magnetic device that is configured to magnetically couple the drone 200 to the landing dock 100. For example, the landing dock 100 may include a magnet on a top surface thereof, and the drone 200 may be magnetically attached to the landing dock 100. The magnet may be configured as a permanent magnet or an electromagnet. The electromagnet may be actuated when the drone 200 approaches within the predetermined distance. In some exemplary embodiments, the landing may be executed using a mechanical device of the landing dock 100 that is configured to mechanically capture the drone 200. The mechanical capturing device may include a robotic gripping arm. Alternatively, the landing dock 100 may include a recessed compartment to receive the drone 200. When the drone 200 enters the recessed compartment of the landing dock 100, a door or a shutter may be closed.

In some implementations, orientation angles of the landing dock 100 may be adjusted based on a predicted attitude of the drone 200 at the estimated time of landing to match the orientation angles of the landing dock 100 with the attitude of the drone 200 at the landing. For example, an attitude of the drone 200 and an attitude of the vehicle 10 at the estimated time of landing may be predicted. A difference between the attitude of the drone 200 and the attitude of the vehicle 10 may be estimated. Subsequently, the orientation angles of the landing dock 100 may be adjusted based on the estimated difference between the attitude of the drone 200 and the attitude of the vehicle 10. To prevent unnecessarily adjusting the orientation angles of the landing dock 100 when the drone 200 is still distant (e.g., greater than a predetermined distance), the prediction of the drone attitude and the vehicle attitude, and the adjustment of the landing dock 100 may be performed in response to determining that the estimated time of landing is within a predetermined time. Further, the predetermined time may be set to a sum of a predetermined buffer time and an actuation time that is required to adjust the landing dock 100 to correspond to the predicted attitude of the drone 200 at the time of landing. The attitude of the drone 200 may include a heading direction, a roll angle, a pitch angle, and a yaw angle. The buffer may be determined based on a communication latency, a probability of disturbance during the landing, and/or a safety margin. For example, the buffer may be set to about 1 second.

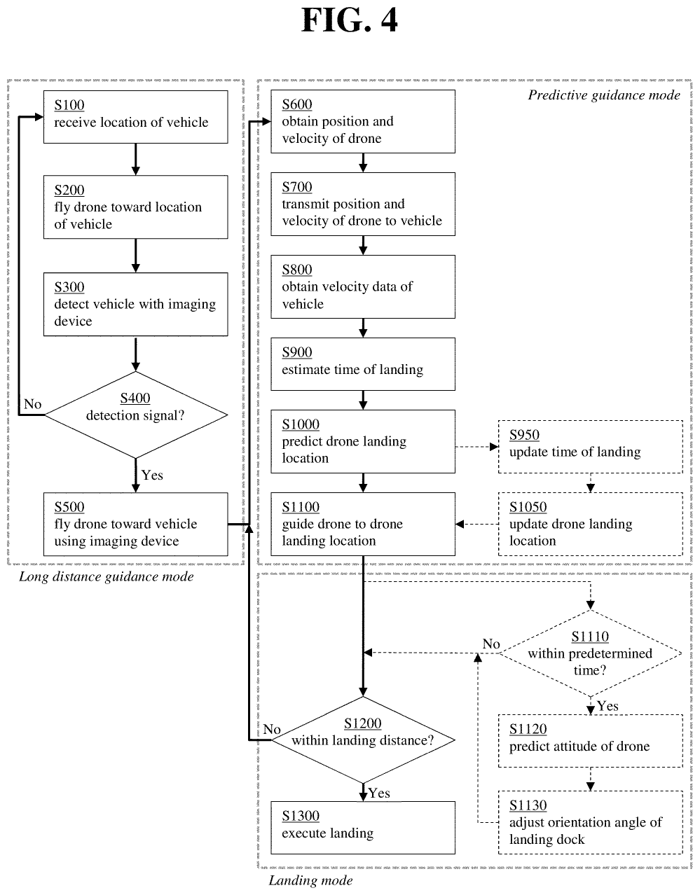

Hereinbelow, steps for a method of predictive drone landing according to an exemplary embodiment of the present disclosure will be described in detail with reference to FIG. 4. FIG. 4 shows a flowchart for a method of predictive drone landing according to an exemplary embodiment of the present disclosure. Referring to FIG. 4, the method of predictive drone landing according to an exemplary embodiment of the present disclosure may include a long distance guidance mode, a predictive guidance mode, and a landing mode.

In the long distance guidance mode, a drone may be configured to receive a location and/or an orientation of a vehicle (S100). The location and the orientation may be obtained based on a GPS, but the present disclosure is not limited thereto. The location and the orientation of the vehicle may be obtained using various other positioning means such as, for example, an IMU. Upon receiving the location and the orientation of the vehicle, the drone may be guided toward the received location of the vehicle for a predetermined time duration (S200). The time duration may be determined based on various conditions such as a distance between the drone and the vehicle, road conditions, traffic conditions, surrounding environment, and the like. The time duration may also be adaptively adjusted. For example, the time duration may be set to 1 minute when the distance between the drone and the vehicle is greater than 1 km, to 10 seconds when the distance is between 1 km and 100 m, and to 1 second when the distance is less than 100 m. As another example, the time duration may be set to 10 seconds in a highway environment, and to 1 second in an urban environment.

After flying toward the vehicle for the predetermined time duration, the drone may attempt to detect the vehicle and/or a landing dock of the vehicle using an imaging device (S300). The imaging device may be mounted within the drone or within the vehicle. When the landing dock of the vehicle is detected by the imaging device, the drone may be configured to transmit a detection signal to the controller of the vehicle. Further, the controller may be configured to receive the detection signal from the drone (S400). In response to receiving the detection signal (“yes” of S400), the drone may be guided toward the vehicle via a computer vision guidance based on the imaging device (S500), and the drone guidance method may proceed to the predictive guidance mode and begin obtaining the relative position of the drone with respect to the landing dock using the imaging device. In response to failing to receive the detection signal (“no” of S400), the drone may repeat steps S100 through S400.

In the predictive guidance mode, a location of the drone may be obtained (S600). The location of the drone may be obtained using an imaging device via vision recognition-based techniques. In some exemplary embodiments, the location of the drone may be obtained or enhanced using a GPS mounted within the drone. By obtaining the locations of the drone and the landing dock, a relative position of the drone with respect to the landing dock mounted on the vehicle may be determined. The position data may include a distance between the drone and the landing dock, an azimuth angle of the drone with respect to the landing dock, altitudes of the drone and the landing dock, roll, pitch, and yaw angles of the drone with respect to the vehicle, or the like. Further, velocity vectors of the drone may be obtained. In step S700, the obtained relative position data and velocity data may be transmitted to a controller within the vehicle. The controller may be configured to obtain velocity data of the vehicle from various onboard sensors mounted therein (S800). Based on the position data from the drone and the vehicle, and the velocity data from the drone and the vehicle, the controller may be configured to estimate a time of landing (S900). In step S1000, the controller may be configured to predict a location of the vehicle at the estimated time of landing and define the predicted location as a drone landing location. In predicting the drone landing location, the controller may be configured to use various driving data of the vehicle, including a speed of the vehicle, a calculated route from a navigation system of the vehicle, a road traffic condition, a 2-D map data, a 3-D map data, ADAS data, and traffic data received via a V2X communication.

In some implementations, to further improve the accuracy of the prediction of the drone landing location, the controller may be configured to update the estimated time of landing based on the predicted location of the vehicle (S950). The controller may also be configured to update the predicted location of the vehicle based on the updated time of landing, and define the updated location of the vehicle as the updated drone landing location (S1050). Steps S950 and S1050 may be repeated multiple times to iteratively determine the time of landing and the drone landing location.

Further, the controller may be configured to guide the drone to the drone landing location (S1100). During step S1100, the controller may be configured to generate a route (e.g., path) of the drone to guide the drone toward the drone landing location at the estimated time of landing, and provide the generated route to the drone. In particular, the drone route may be generated to circumvent obstacles (e.g., buildings, trees, traffic lights, other vehicles, other drones, and the like) that may exist between the drone and the drone landing location.

In some exemplary embodiments, the controller may be configured to estimate a remaining flight duration of the drone based on a state-of-charge of the battery (e.g., voltage of the battery), and determine whether the remaining flight duration is sufficient to operate the drone until the estimated time of landing. Subsequently, in response to determining that the remaining flight duration of the drone is less than a time to the estimated time of landing, the controller may be configured to adjust the routes of the drone and/or the vehicle to adjust the time to the estimated time of landing to become less than the remaining flight duration of the drone. Additionally, the controller may be configured to estimate, or receive an estimation from the vehicle, a remaining cruise duration of the vehicle based on, for example, a fuel level and a gas mileage (e.g., fuel efficiency) of the vehicle. Subsequently, the controller may be configured to determine whether the remaining cruise duration of the vehicle is sufficient to operate the vehicle until the estimated time of landing. In response to determining that the remaining cruise duration of the vehicle is less than the time to the estimated time of landing, the controller may be configured to adjust the routes of the drone and/or the vehicle to adjust the time to the estimated time of landing to become less than the remaining cruise duration of the vehicle.

When the drone approaches the landing dock of the vehicle and enters within a landing range, the landing mode may be initiated. In the landing mode, the controller may be configured to determine whether a distance between the drone and the landing dock is within a predetermined distance (S1200), and execute the landing in response to determining that the distance between the drone and the landing dock is within the predetermined distance (S1300).

In some implementations, orientation angles of the landing dock may be adjusted to match the attitude (e.g., heading direction, roll, pitch, and yaw angles) of the drone during landing. In particular, the controller may be configured to determine whether the estimated time of landing is within a predetermined time (S1110). In response to determining that the estimated time is within the predetermined time, the controller may be configured to predict the attitude of the drone and the attitude of the vehicle at the estimated time of landing based on the approach direction, the descent angle, and the like (S1120). The controller may also be configured to estimate a difference between the attitude of the drone and the attitude of the vehicle. Subsequently, the orientation angles of the landing dock may be adjusted with respect to the vehicle to correspond to the estimated difference between the attitude of the drone and the attitude of the vehicle (S1130). The predetermined time to initiate the orientation angle adjustment of the landing dock may be set based on an actuation time that is required to adjust the landing dock to correspond to the predicted attitude of the drone. To ensure a buffer or a margin, the predetermined time may be set to a sum of a predetermined buffer and the actuation time required to adjust the landing dock. For example, the predetermined buffer may be set to about 1 second.

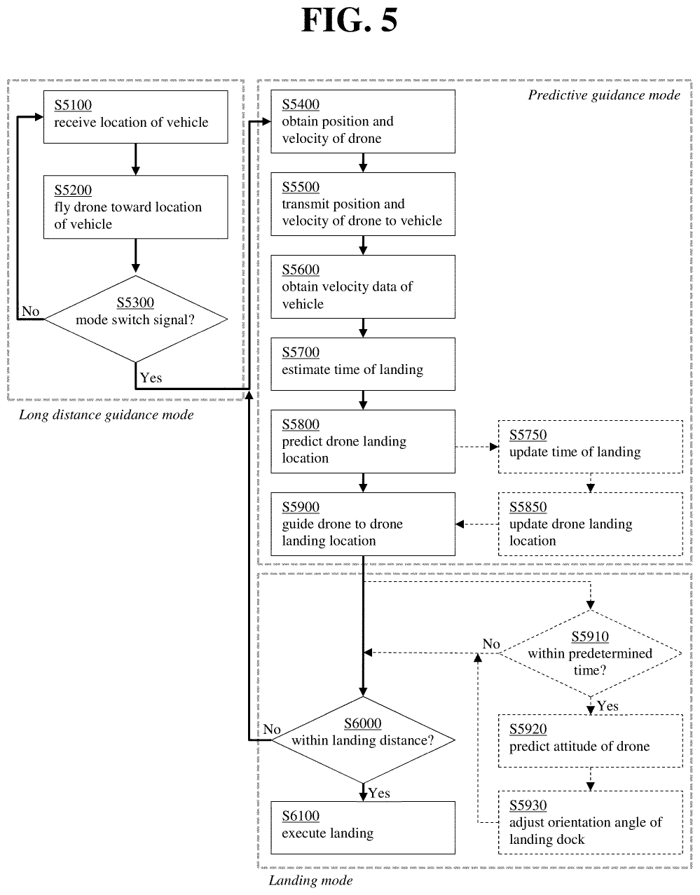

FIG. 5 shows a flow chart for a method of predictive drone landing according to another exemplary embodiment of the present disclosure. In this exemplary embodiment, a drone may be configured to receive a location and/or an orientation of a vehicle (S5100). The location and the orientation may be obtained based on a GPS, but the present disclosure is not limited thereto. The location and the orientation of the vehicle may be obtained using various other positioning devices such as, for example, an IMU. Upon receiving the location and the orientation of the vehicle, the drone may be guided toward the received location of the vehicle for a predetermined time duration (S5200). Subsequently, the predictive guidance mode may be initiated upon receiving a control signal to switch the guidance mode (e.g., a mode switch signal) from the long distance guidance mode to the predictive guidance mode (“yes” of S5300).

Accordingly, the predictive guidance mode may be initiated without the drone visually detecting the landing dock. For example, during at least a part of the predictive guidance mode, the location data of the drone and the vehicle may be provided by the GPS without an imaging device. Furthermore, the long distance guidance mode and the predictive guidance mode may be switched back and forth by control signals (e.g., mode switch signals). The predictive guidance mode (S5400-S5900) and the landing mode (S5910-S6100) may be the same or similar to the predictive guidance mode (S600-S1100) and the landing mode (S1110-S1300) described above in regards to FIG. 4, and therefore, a description thereof is omitted.

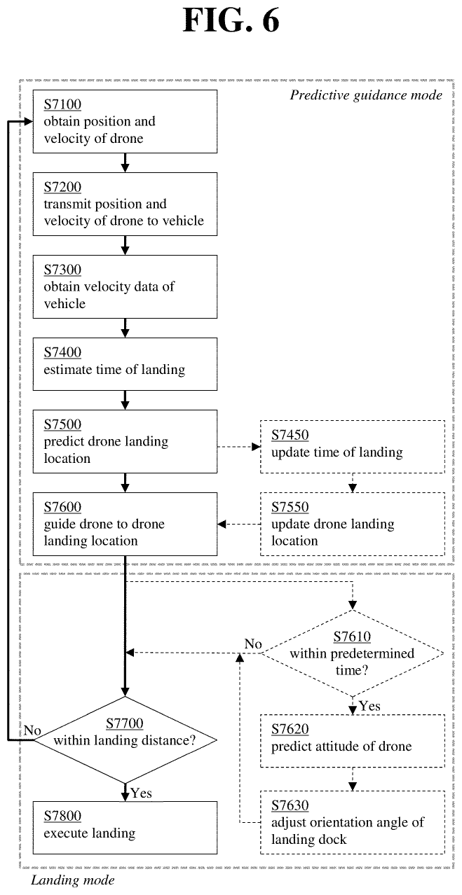

FIG. 6 shows a flow chart for a method of predictive drone landing according to yet another exemplary embodiment of the present disclosure. In the exemplary embodiment shown in FIG. 6, the predictive guidance mode may be used without a long distance guidance mode. The position data of the drone and the vehicle may be obtained using the GPS, the imaging device, or both. In this exemplary embodiment, the predictive guidance mode (S7100-7600) and the landing mode (S7610-S7800) may be the same or similar to the predictive guidance mode (S600-S1100) and the landing mode (S1110-S1300) described above in regards to FIG. 4, and therefore, a description thereof is omitted.

The method of predictive drone landing according to exemplary embodiments of the present disclosure has been described for a case in which the vehicle is in motion. However, the present disclosure is not limited thereto, and the method may be applied similarly to a stationary vehicle. Moreover, the method has been described for actually landing the drone on the landing dock. However, the present disclosure is not limited thereto. In some implementations, the method may be used to guide the drone to follow a target with a predetermined separation. For example, the drone may be guided to follow the target while maintaining a predetermined distance from the target. For such implementations, a virtual (or actual) point may be defined with respect to the target, and the location of the virtual point may be predicted instead of the location of the landing dock. The drone may be guided to follow the virtual point. In these implementations, the drone may continuously observe the target or take images thereof while maintaining a particular distance from the target. Alternatively, the drone may be guided to follow the virtual point while executing specific maneuver patterns, for example, circle, loop, barrel roll, upward spiral, downward spiral, zig-zag, zoom in, and/or zoom out.

In some exemplary embodiments, the predictive guidance of the drone may be implemented by including a machine learning algorithm. For example, the drone landing location may be predicted based on the driving data of the vehicle as well as heuristic data from previous executions. The guidance algorithm may evaluate the probabilities of a plurality of candidate landing locations, and a landing location may be predicted in a probabilistic manner. In evaluating the probabilities, heuristic data may be used. Separate training data may be provided for the learning phase.

Another aspect of the present disclosure provides a system for predictive drone landing. The system for predictive drone landing according to an exemplary embodiment of the present disclosure may include a landing dock mounted on a vehicle and a controller. In some exemplary embodiments, the system may also include a drone configured to autonomously land on the landing dock of the vehicle. The controller may include a memory configured to store program instructions and a processor configured to execute the program instructions. In particular, when the program instructions are executed, the controller may be configured to obtain a relative position of a drone with respect to the landing dock and determine a relative velocity of the drone with respect to the landing dock. Based on the relative position and the relative velocity of the drone with respect to the landing dock, the controller may be configured to estimate a time of landing. Subsequently, the controller may be configured to predict a location of the vehicle at the estimated time of landing as a drone landing location based on driving data of the vehicle and flight conditions of the drone.

Further, for predicting the drone landing location, one or more of a speed of the vehicle, a calculated vehicle route from a navigation system of the vehicle, a road traffic condition, a 2-D map data, a 3-D map data, an ADAS data, and traffic data received via a V2X communication may be used as the driving data. For collecting the driving data thereof, the vehicle may include an on-board diagnostics (OBD) bus to detect velocity, acceleration, and driver input data. The 2-D map and the 3-D map may be downloaded and pre-stored in the controller, or may be referenced to from an external source. The vehicle may include various navigation equipment to obtain heading, route, speed, traffic condition, and location (GPS or inertial) data. The vehicle may further include a radar to measure the distance to and speed of an adjacent vehicle, a Lidar to update the 3-D map data and to identify obstacles, and/or an ultrasonic sensor to determine distances to proximate objects. These proximity sensors may issue warnings and cause a driving path to deviate, and accordingly, provide inputs to the prediction of the drone landing location. Further, the vehicle may include an imaging device for capturing images of objects and obstacles as well as for detecting the drone from the vehicle side. The vehicle may include a communication link configured to to communicate with the drone or with an extraneous guidance server for operating the predictive drone landing system. The communication link may include radio, WiFi, cellular, Bluetooth, and the like.

For collecting flight data thereof, the drone may include various equipment such as a gyroscope and an accelerometer to determine the attitude (e.g., roll, pitch, and yaw) and/or the angular/linear acceleration of the drone. The drone may also include a GPS and/or an IMU to determine the location, acceleration, and/or velocity of the drone. The drone may include an imaging device capable of computer vision recognition. Further, the drone may include a communication link configured to communicate with the vehicle or with an extraneous guidance server that operates the predictive drone landing system. The communication link may include radio, WiFi, cellular, Bluetooth, and the like. In addition, the landing dock may include a dock actuator configured to adjust the orientations angles of the landing dock.

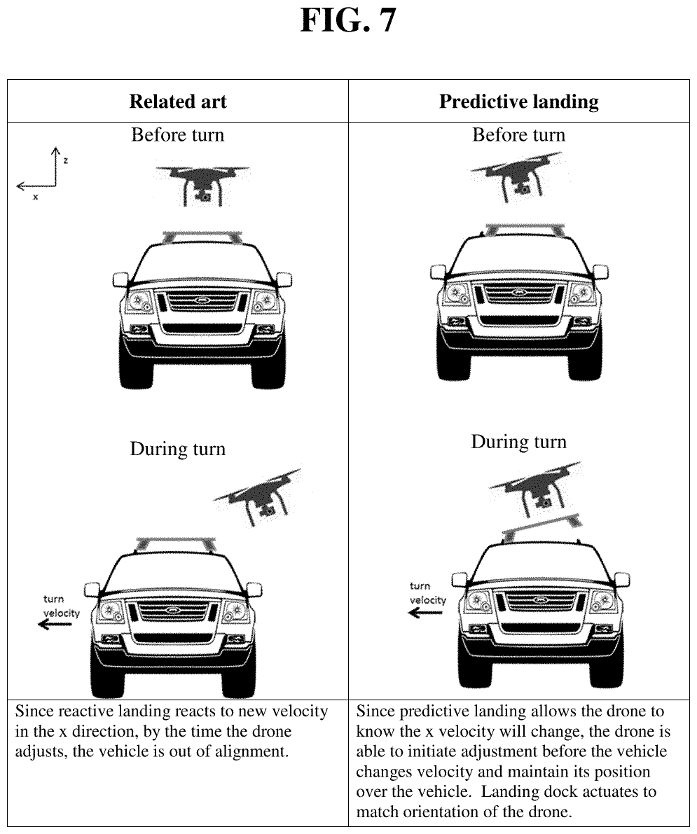

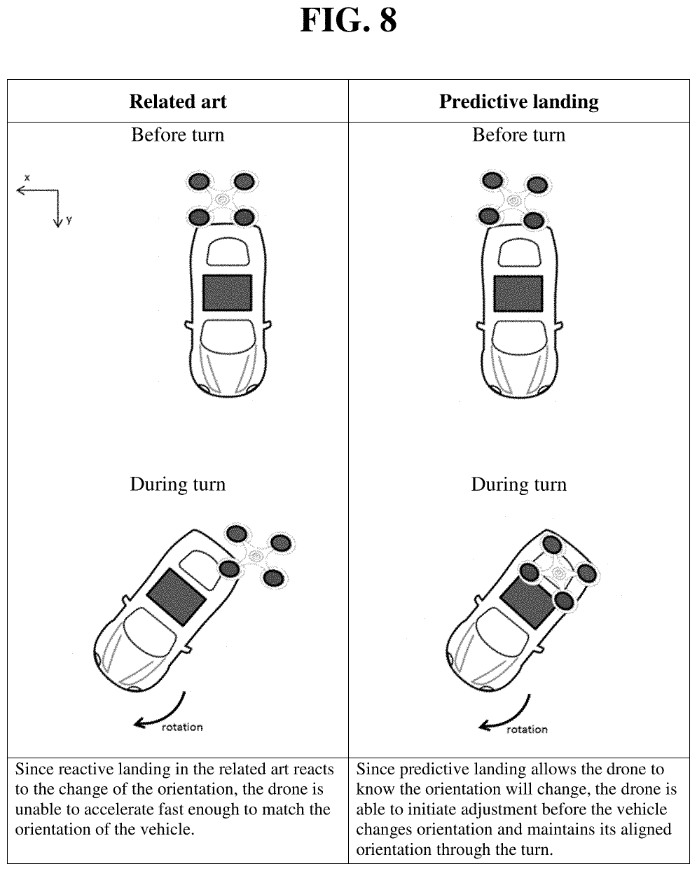

As set forth above, according to exemplary embodiments of the present disclosure, a drone may be guided to a vehicle based on a prediction of the vehicle location and orientation at an estimated time of landing, thereby decreasing a time required for the landing procedure and also decreasing a chance for colliding or failing to land. FIG. 7 schematically compares initiation of path changes of a drone with the predictive landing according to exemplary embodiments of the present disclosure with a drone in the related art, and FIG. 8 schematically compares initiation of orientation changes of a drone with the predictive landing according to exemplary embodiments of the present disclosure with a drone in the related art. As shown in FIGS. 7 and 8, the predictive landing may provide advantages for more closely following the vehicle by initiating the path and/or orientation adjustments prior to the vehicle changes the path and/or the orientation. Accordingly, predictive guidance of the drone may decrease the energy consumption by planning a more effective (e.g., shortest) route and by requiring the control instructions to be updated less frequently compared with the reactive guidance of related art. The predictive guidance of the drone may minimize intervention and effort from a driver of the vehicle as well.

Hereinabove, although the present disclosure is described by specific matters such as concrete components, and the like, the exemplary embodiments, and drawings, they are provided merely for assisting in the entire understanding of the present disclosure. Therefore, the present disclosure is not limited to the exemplary embodiment. Various modifications and changes may be made by those skilled in the art to which the disclosure pertains from this description. Therefore, the spirit of the present disclosure should not be limited to the above-described exemplary embodiments, and the following claims as well as all technical spirits modified equally or equivalently to the claims should be interpreted to fall within the scope and spirit of the disclosure.

What is claimed is:

1. A method for predictive drone landing, comprising:
obtaining, by a processor, a relative position of a drone with respect to a landing dock mounted on a vehicle;
obtaining, by the processor, a relative velocity of the drone with respect to the landing dock;
estimating, by the processor, a time of landing based on the relative position and the relative velocity of the drone with respect to the landing dock; and
predicting, by the processor, a location of the vehicle at the estimated time of landing as a drone landing location based on driving data of the vehicle and flight conditions of the drone.

2. The method of claim 1, wherein the drone landing location is predicted based on at least one of a speed of the vehicle, a calculated vehicle route from a navigation system, a road traffic condition, a 2-D map data, a 3-D map data, advanced driver-assistance system (ADAS) data, and traffic data received via a vehicle-to-everything (V2X) communication.

3. The method of claim 2, wherein the calculated route from the navigation system includes road curves, elevations, or both.

4. The method of claim 1, further comprising:
updating, by the processor, the estimated time of landing based on the predicted location of the vehicle; and
updating, by the processor, the predicted location of the vehicle based on the updated time of landing.

5. The method of claim 1, further comprising:
guiding, by the processor, the drone to the drone landing location,
wherein the guiding the drone includes:
generating, by the processor, a drone route to reach the drone landing location at the estimated time of landing; and
providing, by the processor, the drone with the generated drone route.

6. The method of claim 1, further comprising:
determining, by the processor, whether a distance between the drone and the landing dock is within a predetermined distance; and
executing, by the processor, landing in response to determining that the distance between the drone and the landing dock is within the predetermined distance.

7. The method of claim 1, wherein the relative position of the drone with respect to the landing dock is obtained using an imaging device.

8. The method of claim 5, wherein the route is generated to circumvent an obstacle between the drone and the drone landing location.

9. The method of claim 1, further comprising:
determining, by the processor, whether the estimated time of landing is within a predetermined time;
predicting, by the processor, an attitude of the drone and an attitude of the vehicle at the estimated time of landing in response to determining that the estimated time of landing is within the predetermined time;
estimating a difference between the predicted attitude of the drone and the predicted attitude of the vehicle; and
adjusting orientation angles of the landing dock based on the estimated difference between the attitude of the drone and the attitude of the vehicle.

10. The method of claim 9, wherein the predetermined time is a sum of a predetermined buffer and an actuation time required to adjust the landing dock to correspond to the predicted attitude of the drone.

11. The method of claim 6, wherein the landing is executed using magnetic coupling between the drone and the landing dock.

12. The method of claim 6, wherein the landing is executed using a mechanical capturing device.

13. The method of claim 1, further comprising:
transmitting, by the processor, a current location of the vehicle to the drone based on a global position system (GPS);
providing, by the processor, the drone with a route to the current location of the vehicle; and
receiving, by the processor, a detection signal which indicates that the relative position of the drone with respect to the landing dock is detected using an imaging device.

14. The method of claim 13, further comprising:
transmitting, by the processor, a current orientation of the vehicle to the drone.

15. The method of claim 13, further comprising:
obtaining, by the processor, the relative position of the drone with respect to the landing dock in response to receiving the detection signal.

16. The method of claim 1, further comprising:
estimating, by the processor, a remaining flight duration of the drone; and
determining, by the processor, whether the remaining flight duration of the drone is longer than a time to the estimated time of landing.

17. The method of claim 1, further comprising:
estimating, by the processor, a remaining cruise duration of the vehicle; and
determining, by the processor, whether the remaining cruise duration of the vehicle is longer than a time to the estimated time of landing.

18. A system for predictive drone landing, comprising:
a landing dock mounted on a vehicle; and
a controller comprising a memory configured to store program instructions and a processor configured to execute the program instructions, the program instructions when executed configured to:
obtain a relative position of a drone with respect to the landing dock;
obtain a relative velocity of the drone with respect to the landing dock;
estimate a time of landing based on the relative position and the relative velocity of the drone with respect to the landing dock; and
predict a location of the vehicle at the estimated time of landing as a drone landing location based on driving data of the vehicle and flight conditions of the drone.

19. The system of claim 18, wherein the program instructions when executed are further configured to:
obtain a relative orientation of the drone with respect to the landing dock; and
estimate the time of landing based on the relative orientation of the drone with respect to the landing dock.

20. The system of claim 18, wherein the drone landing location is predicted based on at least one of a speed of the vehicle, a calculated vehicle route from a navigation system, a road traffic condition, a 2-D map data, a 3-D map data, advanced driver-assistance system (ADAS) data, and traffic data received via a vehicle-to-everything (V2X) communication.
